(19) United States
(12) Patent Application Publication
(10) Pub. No.: US 2025/0352959 A1
(43) Pub. Date: Nov. 20, 2025

(54) SYSTEMS AND METHODS FOR INFUSION OF LIQUID INTO GAS

(71) Applicant: Roger YALDEN, Lincolnshire (GB)

(72) Inventor: Roger YALDEN, Lincolnshire (GB)

(21) Appl. No.: 18/871,803

(22) PCT Filed: Jun. 5, 2023
(86) PCT No.: PCT/IB2023/055769

§ 371 Date: Dec. 4, 2024

(30) Foreign Application Priority Data
Jun. 4, 2022 (GB) 2208215.0

(51) Int. Cl. B01F 23/213; B01F 23/70

(52) U.S. Cl. CPC B01F 23/2131; B01F 23/702

(57) ABSTRACT

Aspects and embodiments of the invention provide methods and systems of infusing liquid into gas. One method according to an aspect of the invention comprises: filling a chamber having a fixed volume with a first gas content at a first pressure: subjecting the gas content to a high-pressure injection of liquid content into the chamber at a second pressure, wherein, the second pressure is higher than a predetermined pressure saturation requirement of the liquid content. One system according to an aspect of the invention comprises: a cylinder (200) comprising at least one chamber of fixed internal volume and having a first end (200a) and a second end (200b); a floating piston (202) arranged within the internal volume of the chamber; a first gas input port that is selectively connected to the first end of the chamber; a second gas input port that is selectively connected to the second end of the chamber; a first liquid input port that is selectively connected to the first end of the chamber; a second liquid input port that is selectively connected to the second end of the chamber; a first exhaust port that is selectively connected to the first end of the chamber; and a second exhaust port that is selectively connected to the second end of the chamber.

### FIELD

Aspects and embodiments of the disclosure relate to systems and methods for infusion of liquid into gas. One non limiting example relates to infusion of an aqueous solution into carbon dioxide.

### BACKGROUND

The present disclosure focuses on a particular use case of infusion of liquid into gas, i.e., carbonation of beverages. It will be appreciated that the systems and methods described herein in are not limited to infusion of an aqueous solution into gas, nor should the disclosure be considered to limit use cases of the present invention to such a use case. For example, systems and methods described herein may be applied to the controlled infusion of various liquids, i.e., blood, plasma, or water into gases, i.e., oxygen or nitrogen, into other.

Carbonation of beverages involves dissolving a high-pressure gas into a base aqueous solution, usually water. Bottled carbonated beverages are generally prepared in a factory in one of two ways: i) by mixing syrup and water in a tank and carbonating in bulk within the tank before filling and capping at low temperature; or ii) by mixing separate syrup and pre-carbonated water streams via a mixing valve/tap into a container, such as a can or bottle, at pressure that is then sealed by way of a cap. In the home environment, carbonated water can be prepared through use of a soda machine. Carbon dioxide is forced into a liquid at pressure to create carbonated water. Syrup, or other flavourings can be added to the carbonated water either before or after carbonation to create a flavoured carbonated beverage.

In a commercial catering environment, there are typically two main types of beverage dispensers: i) pre-mix; and ii) post-mix. A pre-mix system requires a container of syrup that is pre-mixed with water. The mixed content may be carbonated during preparation or within the container.

A post-mix system is more complex and requires separately stored syrup and carbonated water. the syrup and water is delivered to a mixer tap where they are combined. The resulting beverage may then be dispensed via a fountain dispenser or soda gun, for example.

In each of the above examples, the carbon dioxide is introduced into a liquid base through a gas infusion process. Methods of gas infusion generally fall into three different technical categories:
1) Pressurized saturation whereby, the liquid is subjected to surface contact by the infusion gas at high pressure in a pressurized chamber (carboy) whereby natural absorption occurs. This method is often supplemented by chilling of the carboy or pre-chilling the liquid to improve the absorption rate;
2) In-stream gas infusion whereby, the gasses are injected directly into the liquid stream in a volumetrically controlled manner and then passed through a diffusion process to enable saturation to take place in line. This method is often assisted by passing the liquid through a cooling unit to increase the absorption rate; and
3) Membrane transfers whereby, the liquid passes through on one side of an aquaphobic material such as polysulphone whilst the other side is subjected to a high-pressure gas content such that the gasses will transfer across the membrane to the product through the one-way porous material.

Each of the above methods are constrained by time frame issues in terms of gas absorption rates. In the case of pressurized saturation there are constraints relating to system recover. In the case of in-stream gas infusion and membrane transfers limitations of gas infusion into a liquid is determined by the function of the gas pressure and target level of saturation of the gas into the liquid.

It is against the above background that aspects and embodiments of the present invention have arisen.

### SUMMARY

Further areas of applicability of the present invention will become apparent from the detailed description provided hereinafter. The detailed description and specific examples, while indicating the preferred embodiment of the invention, are intended to be given by way of example only.

As used herein, the term infusion shall be interpreted in the context of dissolving/absorbing gases into liquid. Liquids used in beverage preparation may include water, soft drinks, syrups, liquors, cocktails, tea, coffee, non-alcoholic drinks, beers, ciders, or wine, for example. Gases used in beverage preparation may include carbon dioxide, nitrogen, or oxygen, for example.

The present disclosure describes systems and methods for infusing liquid into gas. In one example, a carbonated beverage may be prepared at the point of supply. A chamber may be filled with carbon dioxide to a target pressure that is set according to a volumetric target. Subsequently, water may be injected into the chamber at a pressure that is higher than the pressurized carbon dioxide. The resulting gas/water mix has a saturation that is set based on the beverage type and water pressure. The gas/water mix is then exhausted from the chamber under pressure through a dispenser into a receptacle in advance of consumption. The temperature of the liquid may be set to facilitate a target absorption rate of the gas therein. Furthermore, the target pressure may be adjusted according to the observed liquid temperature in some embodiments. The ratio between the fill pressure of the carbon dioxide and the fill pressure of the liquid content may be varied to drive and provide control over the temperature-pressure saturation process. The following disclosure details several embodiments of the present invention.

There are many advantages provided by the claimed invention, a non-exhaustive summary of which follows:
1) Volumetric control of the dispensing of carbonated drinks is improved;
2) The time frame for saturation is significantly enhanced;
3) Final product is of consistent quality and fizziness;
4) The flavour of the final product can be controlled at the point of supply through variable gas pressure and addition of supplemental gases to the process; and
5) The final product may be re-pressurised.

One aspect of the invention provides a method of infusing liquid into gas, the method comprising: filling a chamber having a fixed volume with a first gas content at a first pressure; subjecting the gas content to a high-pressure injection of liquid content into the chamber at a second pressure, wherein, the second pressure is higher than a predetermined liquid content saturation pressure requirement of the liquid content.

In one embodiment the method further comprises cooling of the liquid content prior to introduction of the liquid chamber into the chamber.

In one embodiment the method further comprises diffusion of the liquid content as it is injected into the chamber.

In one embodiment the liquid content is introduced into the chamber by way of a spraying process.

By introducing the liquid content by way of a spraying process, mechanical agitation of the liquid content is not required.

In one embodiment the spraying process is configured to complete within a predetermined time relative to one or more of: a volume of the chamber, the relative pressure of the liquid content and the gas content, and the temperature of the liquid content.

Electronic or ultrasonic agitation of the liquid content may be used as an alternative or an addition to spraying the liquid into the chamber.

In one embodiment the gas content and the liquid content are filled or introduced into the chamber at a first end thereof.

In one embodiment, filling or introduction of the gas content and liquid content into the chamber forces a floating piston housed within the chamber to move from the first end of the chamber to a second end of the chamber.

In one embodiment, the method further comprises introducing a second gas content from the second end thereof, the second gas content having a pressure higher than the liquid content saturation pressure and urging the floating piston to move from the second end of the chamber to the first end of chamber thus forcing the saturated or infused gas and liquid content out of the chamber via a dispensing port at the first end thereof. The pressure of the second gas content may be set such that it is higher than a pre-determined saturation control/temperature ratio of the liquid and gas content. Consequently, as the second gas content is introduced to the chamber, the saturated or infused gas and liquid content is exhausted from the chamber at the same time.

In one embodiment the gas content comprises: carbon dioxide, nitrogen, or oxygen.

In one embodiment the liquid content is aqueous based.

Another aspect of the invention provides a system for infusing liquid into gas, the system comprising: a cylinder comprising at least one chamber of fixed internal volume and having a first end and a second end; a floating piston arranged within the internal volume of the chamber; a first gas input port that is selectively connected to the first end of the chamber; a second gas input port that is selectively connected to the second end of the chamber; a first liquid input port that is selectively connected to the first end of the chamber; a second liquid input port that is selectively connected to the second end of the chamber; a first exhaust port that is selectively connected to the first end of the chamber; and a second exhaust port that is selectively connected to the second end of the chamber.

In one embodiment the at least one chamber comprises a plurality of chambers, and the first gas input port, first liquid input port, and first exhaust port are defined by a first end plate at the first end of the rotating cylinder, and the second gas input port, second liquid input port, and second exhaust port are defined by a second end plate at the second end of the rotating housing.

In one embodiment the cylinder is rotatable relative to the first end plate and second end plate.

In one embodiment each of the first gas input port, second gas input port, first liquid input port, second liquid input port, first exhaust port, and second exhaust port sequentially connect with successive cylinders as the cylinder rotates.

In one embodiment the system further comprises one or more diffusors within at least one of the plurality of chambers and/or as part of each end plate.

In one embodiment the cylinder is rotatable to sequentially connect each chamber with: i) the first gas input port; ii) the first liquid input port; iii) the second gas input port; iv) the first exhaust port; iv) the second liquid input port; vii) the first gas input port; and viii) the second exhaust port.

In one embodiment the cylinder is movable by way of an electric motor driven at a RPM set according to: i) a pre-determined flow rate; ii) data from a flow metering device; or iii) the relative liquid or gas flow rates. It will be appreciated that other drive means may be utilized, i.e., a turbine, hydraulic or pneumatic drive means, for example.

In one embodiment the floating piston is configured to be driven under pressure to the opposite end of the chamber from which the chamber is being filled with gas and/or liquid.

In one embodiment the floating piston may be driven within the chamber by way of mechanical, electrical or electromagnetic drive means to compress the infused/saturated gas/liquid therein. Instead of a floating piston, a diaphragm may be used in embodiments of the invention.

In one embodiment the cylinder is rotatable between as many positions as there are chambers within the cylinder, wherein the gas and liquid content within a chamber is held under pressure between sequential connection with the first/second liquid input port and first/second exhaust port.

In one embodiment each of the first/second gas input ports, first/second liquid input ports, and first/second exhaust ports are offset from one another.

In one embodiment the first gas input port and second exhaust port and second gas input port and first exhaust port are respectively aligned one with another.

### FIGURES

Aspects and embodiments of the invention will now be described by way of reference to the following figures:

FIG. 1 is a flow chart of a method according to the present disclosure.

FIG. 2 illustrates a chamber of a system according to the present disclosure.

FIG. 3 illustrates a cylinder comprising a plurality of chambers of the present disclosure.

FIG. 3A illustrates end plates comprising a flow matrix for diffusing liquid into gas according to the present disclosure

FIG. 4 is a system diagram of a system according to the present disclosure.

FIG. 5 illustrates a first step of the method according to the present disclosure.

FIG. 6 illustrates a second step of the method according to the present disclosure.

FIG. 7 illustrates a third step of the method according to the present disclosure.

FIG. 8 illustrates a fourth step of the method according to the present disclosure.

FIG. 9 illustrates a fifth step of the method according to the present disclosure.

FIG. 10 illustrates a sixth step of the method according to the present disclosure.

FIG. 11 illustrates a seventh step of the method according to the present disclosure.

FIG. 12 illustrates an eighth step of the method according to the present disclosure.

### DESCRIPTION

The following description of the preferred embodiment(s) is merely exemplary in nature and is no way intended to limit the invention, its application, or uses.

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivatives thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

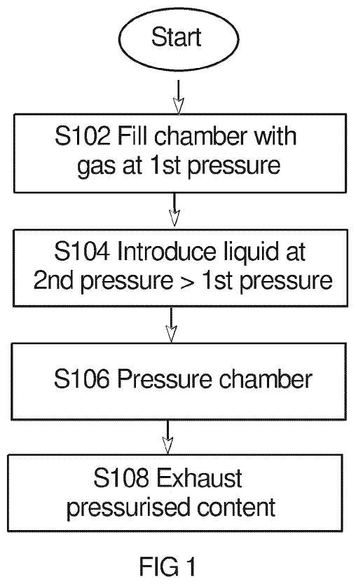

A method according to the disclosure is illustrated at FIG. 1. The method starts at step S100. As step S102, a chamber of fixed volume is filled with a gas at a first pressure. For example, the chamber may be filled with carbon dioxide that is determined based on the desired gas content of the end product. It is expected that a target gas content of 1 vol will require a gas pressure of 1 bar, a target gas content of 2 vol will require a gas pressure of 2 bar, and a target gas content of x vol will require a gas pressure of y vol where x=y. The gas naturally fills the chamber in a uniform manner. At Step S104, a liquid is introduced into the chamber at a pressure that is determined in accordance with the desired saturation, or target gas content, (vol) of the end product, in each case at a higher pressure than the pre-set gas pressure. In some embodiments, the pressure of the liquid is adjusted in accordance with Boyles law to account for variations in liquid temperature. At Step S106 the content of the chamber is pressurized to maintain saturation of the chamber content. At Step S108 the content of the chamber is exhausted. For example, the content of the chamber may define a beverage that is poured into a drinking receptacle for consumption.

In some embodiments, the liquid content may be cooled prior to infusion into the gas content. It is recognized according to Charles law that the absorption rate of gas into liquid, and vice versa, is affected by temperature and that a higher pressure is required to achieve saturation at a higher temperature. There are thus benefits in cooling the liquid content prior to infusion.

For beverages, as per the focus of the present disclosure, the target gas content, or saturation, of the end product may be 4 vol for soft drinks and up to 10 vol, or more for spumante wines. In principle, there is no limit to the target gas content of the end product.

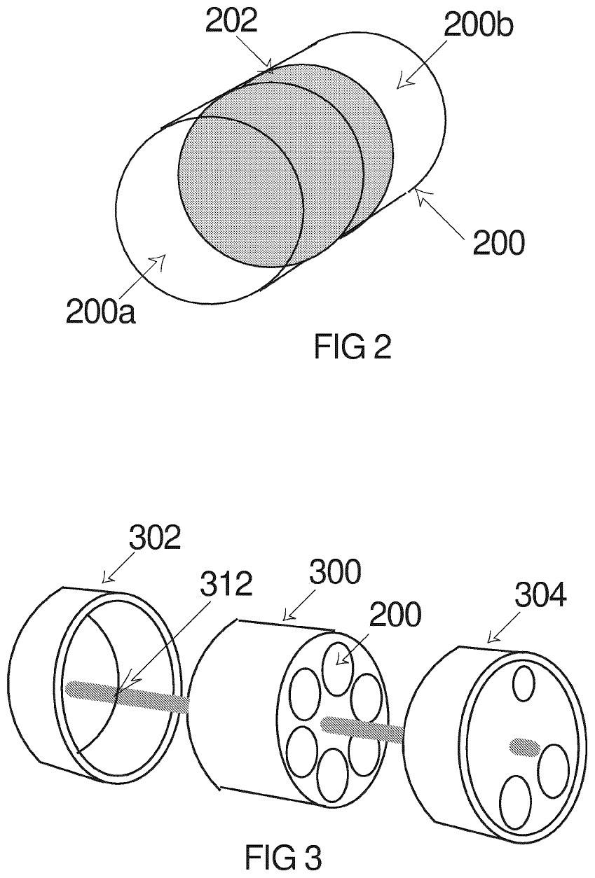

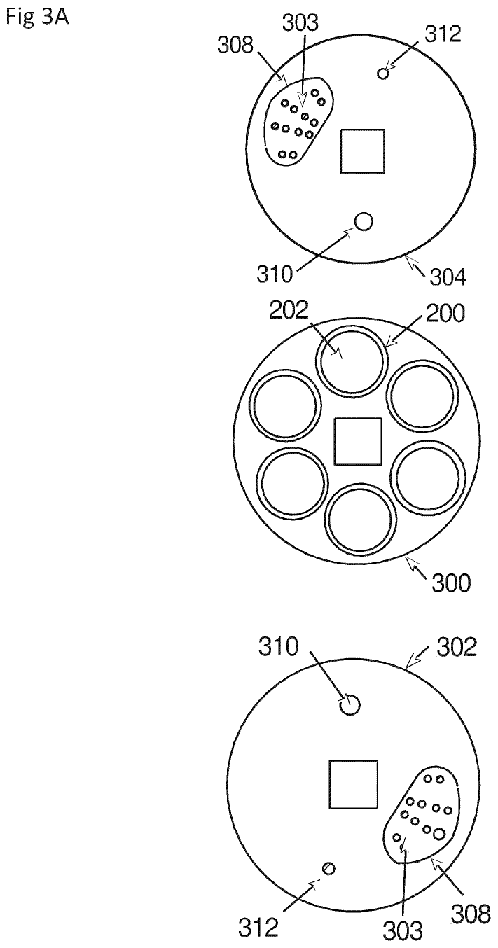

A simplified chamber 200 is illustrated in FIG. 2A. Such a chamber 200 has a fixed and pre-determined volume. Within the chamber 200 there is provided a floating piston 202 that is movable within the chamber 200 between a first end 200a and second end 200b thereof. The chamber 200 may be in cylindrical form. One non-limiting example of a chamber 200 has a diameter of 30 mm and a length of 76 mm. The floating piston 202 may have a thickness of 5 mm. Thus, the volume of an exemplary cylinder may be 3.142×(15 mm²)×71 mm=approx. 50 cu mm. Each end 200a, 200b of the chamber 200 is arranged in sealing contact with a respective end plate 302, 304. Each of end plate 202a, 202b may comprise a matrix of flow channels 303 to enable diffused injection of gas content and water content into the chamber 200. For example, the matrix of flow channels 303 may comprise 4, 6, 8, 10, 12, or more, flow channels 303 of small cross-sectional area compared to the cross-sectional area of the chamber 200. This is shown in more detail in FIG. 3A. The plurality of flow channels 303 facilitate multiple flow paths for the liquid and/or gas content. In some embodiments, a one-way valve may be provided as part of the chamber 200 or as part of each end plate 302, 304. In other embodiments, each chamber 200 remains in sealing contact with respective end plates until it aligns with a gas or liquid input and/or exhaust of an end plate 302, 304. Such an arrangement is described in more detail below.

In a more complex embodiment, the chamber 200 may be one of a plurality of chambers arranged in a revolving configuration around a central axis. As illustrated in FIG. 3, a rotatable cylinder, 300 may be generally cylindrical and define a plurality of chambers 200 extending through the cylinder 300. The cylinder 300 is bounded longitudinally by first and second end plates 302, 304. Each end plate 302, 304 comprises a planar plate with openings 306, 308, 310 therethrough that are fluidically connected to a gas content input, a liquid content input, and exhaust output respectively. A drive shaft 312 extends from the first end plate 302 and acts as the central axis for the cylinder 300 before terminating at the second end plate 304. The drive shaft 312 is drivable by way of an electric motor, or other drive source, configured to cause the cylinder 300 to rotate around the central axis at a speed of 6.6 rpm to provide a dispense rate of 2 litres per minute when the cylinder comprises 6 chambers. All dimensions, speeds and flow rates provided herein are given by way of example only and are not intended to be limiting. The orientation of each of the end plates 302, 304 is fixed relative to the cylinder 300.

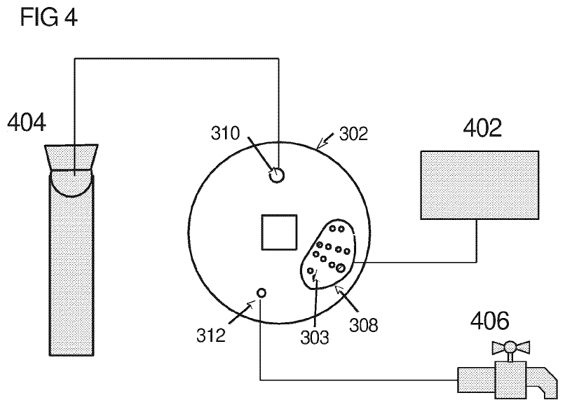

As shown in the system diagram 400 of FIG. 4, a liquid content source 402 is connected to a liquid content input port defined by opening 308 of each of the first and second end plates 302, 304, a gas content source 404 is connected to a gas content input port defined by opening 310 of the first and end plates 302, 304, and a dispenser 406 is connected to an exhaust port defined by opening 312 of the first and second end plates 302, 304. As the cylinder 300 is rotated, each chamber 200 moves sequentially between alignment with each of the liquid content input port 308, gas content input port 310 and exhaust port 312. The cylinder 300 may comprise, 4, 6, 8, 10, 12, or more, chambers 200.

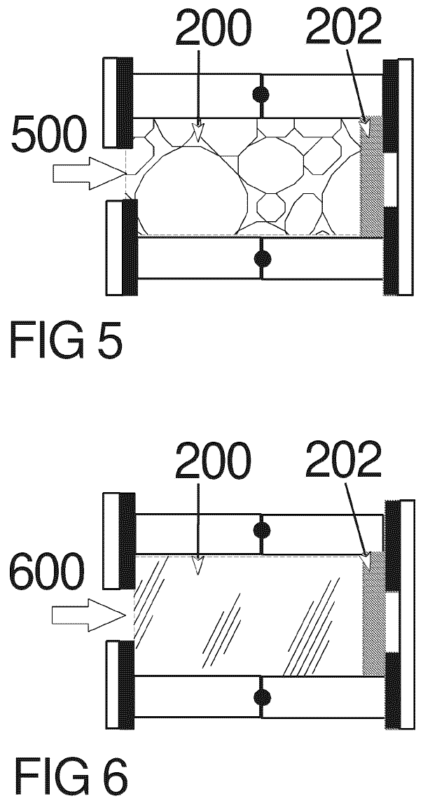

Method steps associated with operation of the system hereinbefore described are shown in FIGS. 5 to 12.

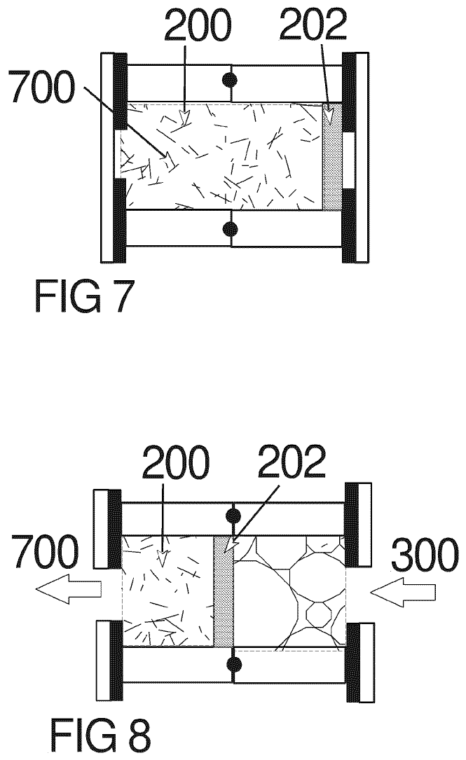

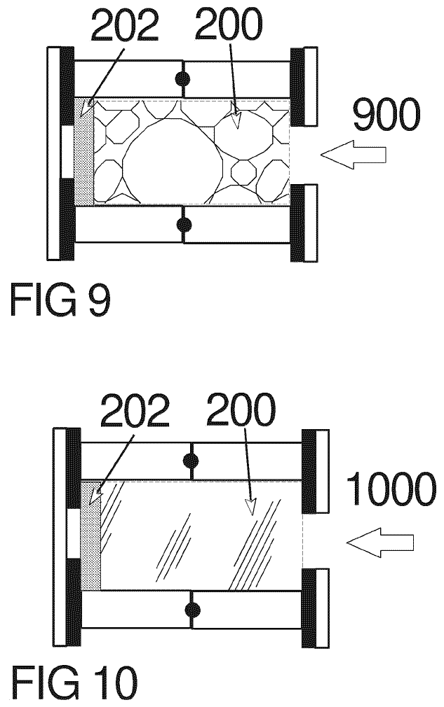

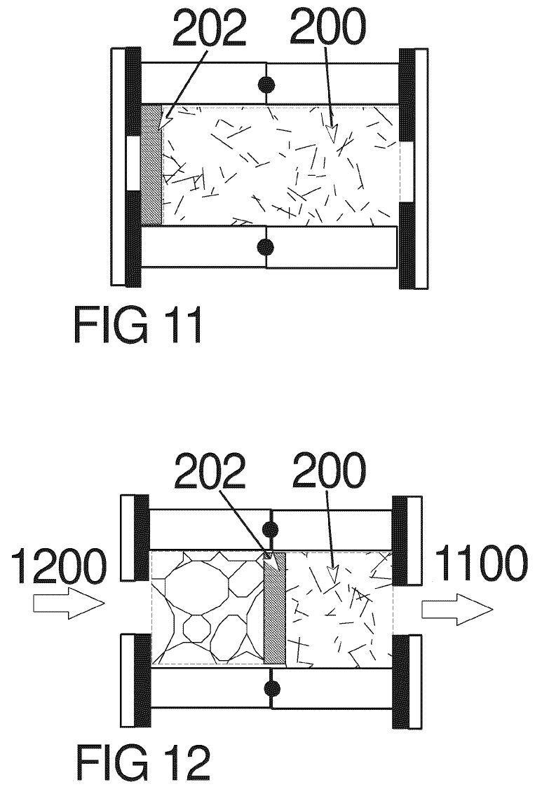

At a first step, as shown in FIG. 5, a chamber 200 is aligned at a first end thereof with the gas content input port 310 of the first end plate 302. A gas 500 having a pre-set pressure is injected into the chamber 200. The pressure of the gas 500 acts against the floating piston 202 to urge the floating piston 202 towards the second end 200b of the chamber 200. At a second step, as shown in FIG. 6, the chamber 200 is aligned at the first end thereof with the liquid content input port 308 of the first end plate 302. A liquid 600 is injected into the chamber 200 at a pressure higher than the gas pressure within the chamber 200. At a third step, as shown in FIG. 7, the gas and liquid 700 are fully saturated. At a fourth step, as shown in FIG. 8, the chamber 200 is aligned at the first end thereof with the exhaust port 312 of the first end plate 302 and at the second end thereof with the gas content input port 310 of the second end plate 304. The pressure of the gas 800 being introduced to the chamber 200 is greater than the pressure of the saturated gas/liquid content and acts against the floating piston 202 to urge the floating piston 202 towards the first end 200a of the chamber 200 and thus dispenses the saturated gas/liquid content 700 from the chamber through the exhaust port 312 of the second end plate 304. At a fifth step. As shown in FIG. 9, the chamber remains aligned at a second end thereof with the gas content input port 312 of the second end plate 304. A gas 900 having a pre-set pressure is injected into the chamber 200. The pressure of the gas 900 acts against the floating piston 202 to urge the floating piston 202 towards the first end 200a of the chamber 200. At a sixth step, as shown in FIG. 10 the chamber 200 is aligned at the second end thereof with the liquid content input port 308 of the second end plate 304. A liquid 1000 is injected into the chamber 200 at a pressure higher than the gas pressure within the chamber 200. At a seventh step, as shown in FIG. 11, the gas and liquid 1100 are fully saturated. At an eighth step, as shown in FIG. 12, the chamber 200 is aligned at the second end thereof with the exhaust port 312 of the second end plate 304 and at the first end thereof with the gas content input port 310 of the first end plate 302. The pressure of the gas 1200 being introduced to the chamber 200 is greater than the pressure of the saturated gas/liquid content 1100 and acts against the floating piston 202 to urge the floating piston 202 towards the second end 200b of the chamber 200 and thus dispense the saturated gas/liquid content 1100 from the chamber 200 through the exhaust port 312 of the first end plate 302.

The above embodiments are exemplary only, and other possibilities and alternatives within the scope of the appended claims will be apparent to those skilled in the art.

1. A method of infusing liquid into gas, the method comprising:
filling a chamber having a fixed volume with a first gas content at a first pressure; and
filling the chamber, comprising the first gas content, with a first liquid content via a spraying process at a second pressure to create an infused liquid-gas product;
wherein:
the first pressure is determined based on an end target volume of the infused liquid-gas product, and
the second pressure higher than the first pressure.

2. The method of claim 1 further comprising cooling of the liquid content and/or the chamber prior to introduction of the liquid content into the chamber.

3. The method of claim 1 further comprising diffusion of the liquid content as it is injected into the chamber.

4. The method of claim 1, wherein the spraying process is configured to complete within a predetermined time relative to one or more of: a volume of the chamber, the relative pressure of the liquid content and the gas content, and the temperature of the liquid content.

5. (canceled)

6. The method of claim 1 wherein the first gas content and the first liquid content are filled or introduced into the chamber at a first end thereof.

7. The method of claim 1 wherein filling the chamber with the first gas content and first liquid content forces a floating piston housed within the chamber to move from a first end of the chamber to a second end of the chamber.

8. The method of claim 1 further comprising:
exhausting the infused liquid-gas product out of the chamber, by refilling the chamber with a second gas content at a third pressure,
wherein the second gas content having a third pressure.

9. The method of claim 1, wherein the gas content comprises carbon dioxide, nitrogen, or oxygen.

10. The method of claim 1, wherein the liquid content is water based.

11. A system for infusing liquid into gas, the system comprising:
a cylinder comprising at least one chamber of fixed internal volume and having a first end and a second end;
a floating piston arranged within the internal volume of the chamber;
a first gas input port that is selectively connected to the first end of the chamber; a second gas input port that is selectively connected to the second end of the chamber;
a first liquid input port that is selectively connected to the first end of the chamber; a second liquid input port that is selectively connected to the second end of the chamber;
a first exhaust port that is selectively connected to the first end of the chamber; and
a second exhaust port that is selectively connected to the second end of the chamber.

12. The system of claim 11, wherein the at least one chamber comprises a plurality of chambers, and the first gas input port, first liquid input port, and first exhaust port are defined by a first end plate located at the first end of the cylinder, and the second gas input port, second liquid input port, and second exhaust port are defined by a second end plate located at the second end of the cylinder.

13. The system of claim 12, wherein the cylinder is movable relative to the first end plate and second end plate.

14. The system of claim 11, wherein each of the first gas input port, second gas input port, first liquid input port, second liquid input port, first exhaust port, and second exhaust port sequentially connect with successive cylinders as the cylinder rotates.

15. The system of claim 13, wherein each chamber of the cylinder is sequentially connected with: i) the first gas input port; ii) the first liquid input port; iii) the second gas input port; iv) the first exhaust port; iv) the second liquid input port; vii) the first gas input port; and viii) the second exhaust port.

16. The system of claim 11, wherein the cylinder is rotatable by way of drive means driven at a RPM set according to: i) a pre-determined flow rate; ii) data from a flow metering device; or iii) the relative liquid or gas flow rates.

17. The system of claim 11, wherein the floating piston of a chamber is configured to be driven under pressure to the opposite end of the chamber from which the chamber is being filled with gas and/or liquid.

18. The system of claim 17, wherein the floating piston may be driven within the chamber by way of mechanical, electrical or electromagnetic drive means.

19. The system of claim 12, wherein the cylinder is rotatable between as many positions as there are chambers within the rotatable housing, wherein the gas and liquid content within each chamber is held under pressure between the first/second liquid input port and first/second exhaust port.

20. The system of claim 21, wherein each of the first/second gas input ports, first/second liquid input ports, and first/second exhaust ports are offset from one another.

21. The system of claim 22, wherein the first gas input port and second exhaust port and second gas input port and first exhaust port are respectively aligned one with another.
